(19) United States
(12) Patent Application Publication
(10) Pub. No.: US 2016/0070324 A1
(43) Pub. Date: Mar. 10, 2016

(54) Advanced Power Strip

(71) Applicant: TrickleStar Ltd., Central (HK)

(72) Inventors: Bernard Christopher Emby, Kuala Lumpur (MY); Thomas Joergensen, Copenhagan O (DK)

(21) Appl. No.: 14/693,329

(22) Filed: Apr. 22, 2015

Related U.S. Application Data
(60) Provisional application No. 62/045,800, filed on Sep. 4, 2014.

(51) Int. Cl. G06F 1/26; G06F 1/32; G06F 13/364; G06F 13/40; G06F 13/42

(52) U.S. Cl. CPC G06F 1/266; G06F 13/4022; G06F 13/4282; G06F 13/4068; G06F 13/364; G06F 1/3287

(57) ABSTRACT

An advanced power strip includes a housing having at least one control outlet, at least one switched outlet, and at least one auxiliary input port; and at least one auxiliary device coupled to the at least one auxiliary input port. The advanced power strip can be configured to a) allow for master/slave control sensing the current produced by a control device coupled to the at least one control outlet, and, if current is detected, allowing current to be drawn by any device coupled to the at least one switched outlet; and b) allow for manual control of the switched outlets via the at least one auxiliary device coupled to the at least one auxiliary input port.

### CROSS REFERENCE TO RELATED APPLICATION

This application claims the benefit of U.S. Provisional Application No. 62/045,800, filed Sep. 4, 2014, the disclosure of which is hereby incorporated by reference in its entirety.

### BACKGROUND OF THE INVENTION

1. Field of the Invention

The present invention relates generally to electrical power delivery devices, and, more particularly, to an energy saving electrical extension cord with electrical outlets (commonly referred to as a “power strip”) having a master outlet/USB input that controls a number of slave outlets automatically and has the ability for a user to manually control the slave outlets using an input device or for a sensor to provide additional control.

2. Description of Related Art

One type of electrical extension cord, commonly known as a power strip, generally comprises an elongated box-like housing having a row of plug-receiving receptacles formed therein, an on/off switch, and a single power cord which is connectable to a standard AC nominal 110 volt (foreign 220 volts) wall or other outlet. The power cord is typically plugged into the power outlet to energize the power strip. Thereafter, a plurality of devices may be plugged into the various plug receiving receptacles of the power strip. When the on/off switch of the power strip is turned to its “ON” position, current will flow to the plug-receiving receptacles and any devices which are plugged into the receptacles will become energized. Conversely, when the on/off switch is placed in its “OFF” position, devices which are plugged into the electrical power strip will become de-energized. Some of the currently available electrical power strips include resettable circuit breakers and generally include circuitry involving power surge suppression and noise filtration, to protect the personal computer from power surges, noise that comes from standard AC power, and power outages or blackouts. Some power controllers also include backup power supply in the form of a battery that can sustain the computer if a power outage or blackout occurs. These conventional power controller devices function to transmit power to a computer and peripheral devices, but generally fail to affect any operative functions of the computer or its peripheral devices.

In addition, these conventional power strips do not reduce or eliminate vampire power unless the power strip is switched to the “OFF” position. Also known as standby power, leaking electricity, or phantom load, vampire power is wasted electrical energy consumed while certain appliances are switched off but still plugged in. These appliances range from televisions, home entertainment systems, personal computers and peripherals, to space heaters, room air-conditioners, and coffee pots. All of these appliances continue to draw power even when they are turned off. Averaging 10-15 watts per hour per device, vampire power is a constant drain on a person's wallet as well as the electrical grid.

Accordingly, advanced power strips have been developed to address the problem of vampire power. These advanced power strips include a master outlet and/or a USB input and a plurality of slave outlets. A personal computer or television is connected to the master outlet and/or the USB input and peripheral devices related to the personal computer or television are connected to the slave outlets. When the personal computer or television is turned on, the peripheral devices connected to the slave outlets are switched on and vice versa when the personal computer or television is turned off. Accordingly, the switching is performed automatically.

However, such a system prevents the use of the peripheral devices unless the personal computer or television is turned on. For instance, in a home theater installation, there are a range of components, such as an AV receiver, DVD player, speakers, etc., which may be used while watching television. However, many of these components may also be used, such as to play music, when the television is turned off. Accordingly, if a person wants to listen to music, he/she needs to switch on the television so that the AV receiver, DVD player, and speakers, which are connected to the slave outlets, can be provided with power. In this scenario it is not desirable to switch on the television in order to listen to music. This is a severe limitation of advanced power strips and in many cases will prevent a person from installing an advanced power strip.

Master/Slave advanced power strips used in a home theater installation will typically use current sensing of a master device such as a television in order to control the peripheral devices/switched outlets. Master/Slave advanced power strips used with desktop personal computers will typically use current sensing to control peripheral devices. However, notebook and netbook computers typically require USB port sensing functionality. This is due to the fact that notebook personal computers have a battery which will regularly enter a charging cycle. A Master/Slave advanced power strip using current sensing cannot distinguish if the notebook personal computer has commenced a charging cycle or has been switched on and so will switch on the peripherals. This behavior is not desirable. Accordingly, USB port sensing is the most appropriate option to sense the status of a notebook personal computer.

Accordingly, the needs exist for 1) an advanced power strip that supports a number of selectable modes and 2) an advanced power strip having a master/slave functionality that controls a number of slave outlets automatically and has the ability for a user to manually control the slave outlets using an input device or for an additional sensor such as a movement sensor to be connected.

### SUMMARY OF THE INVENTION

An object of the present invention is to provide an advanced power strip having a master outlet/USB input that controls a number of slave outlets automatically and has the ability for a user to manually control the slave outlets using an input device or for a sensor to be connected and provide an additional level of control of the slave outlets. Accordingly, the advanced power strip operates as an energy saving power strip by controlling the slave or switched outlets based on the condition or conditions of selected inputs, such as the input provided by a control outlet, a USB port and/or an auxiliary device.

Environments where the use of the advanced power strip of the present invention would be particularly useful are in a computing environment or in a home theater environment. More specifically, the advanced power strip of the present invention would be capable of controlling personal computer peripheral devices (i.e., “slave devices” such as printers, scanners, routers, mobile phone chargers, shredders, etc.) with a “master device” that is typically a desktop computer, notebook computer, or netbook. In addition, the advanced power strip of the present invention would be capable of controlling audio/video peripheral devices (i.e., “slave devices” such as an amplifier, a satellite decoder, a DVD recorder, a game console, a sub-woofer, etc.) with a “master device” that is typically an LCD/plasma display or a CRT television.

The advanced power strip of the present invention includes a housing having at least one control outlet; at least one switched outlet; and at least one auxiliary input port; and at least one auxiliary device coupled to the at least one auxiliary input port. The advanced power strip can be configured to either a) allow for master/slave control sensing the current drawn by a control device coupled to the at least one control outlet, and, if current is detected, allowing current to be drawn by any device coupled to the at least one switched outlet; and b) allow for manual control of the switched outlets via the at least one auxiliary device coupled to the at least one auxiliary input port.

The at least one auxiliary device may be one of: a footswitch, a desktop switch, a motion detection sensor, a motion magnetic contact sensor, a motion current detection sensor, a light level sensor, a temperature sensor, an infrared red learner and receiver to momentary/latching digital output, and a timer.

The advanced power strip may further include a USB port provided on the housing for detecting the presence or absence of 5 VDC on a USB port of a personal computer. The advanced power strip may further include a selector switch provided on the housing for selecting between a plurality of modes of operation. The plurality of modes of operation may include auxiliary mode, current mode, and USB mode.

Accordingly, the advanced power strip of the present invention includes different selectable modes whereby: different relationships can be assigned between an input (or combination of inputs) and outlets; outlets can function in different ways subject to the Mode that is selected on the power strip; and Master/Slave functionality (via current sensing or USB port voltage sensing) and concurrent and/or independent control of selected outlets via a wired, low voltage, external auxiliary input device can be provided. For instance, several of these modes will be discussed hereinafter.

When in auxiliary mode, the switched outlets can only be controlled by the at least one auxiliary device. The current detecting performed by the at least one control outlet and/or the USB port is disabled. The at least one auxiliary device can be used to either latch or toggle the switched outlets on or off and the control outlet functions as an always on outlet. Accordingly, the switched outlets do not turn on or off when a control device coupled to the control outlet is turned on or off. Instead, the switched outlets are turned on or off based on an input received from low-voltage, external auxiliary input device.

When in current mode, the at least one switched outlet turns on or off with the at least one control outlet. More specifically, a control device, such as a personal computer or a television, may be coupled to the control outlet. When the control device is turned on, the at least one switched outlet turns on and when the control device is turned off, the at least one switched outlet turns off. The control outlet senses if the control device, such as a personal computer or television, coupled thereto is above or below a switching threshold and then switches the at least one switched outlet on or off. When in current mode, the auxiliary device can be used to toggle or latch the at least one switched outlet.

When in USB mode, the USB port senses presence or absence of 5 VDC on the USB port of a personal computer. When the personal computer is on, the USB port of the personal computer is on, 5 VDC is sensed by the USB port, and the at least one switched outlet is switched on. On the other hand, when the personal computer is off, the USB port of the personal computer is off, no voltage is sensed, and the at least one switched outlet is switched off. The control outlet operates as an always-on outlet when in USB mode. In addition, the auxiliary device can be used to toggle or latch the at least one switched outlet.

The advanced power strip may further include a high level interface positioned within the housing for allowing communication between the advanced power strip and a personal computer or any other suitable control device. This communication may be performed over a hard wire connection or wirelessly. The advanced power strip may also operate in system mode. When in system mode, the at least one switched outlet is switched on or off by an input received from a personal computer or other suitable control device through the high level interface. When in system mode, the auxiliary device can be used to toggle or latch the at least one switched outlet. System mode also supports current measurement. Current measurement is the ability of the advanced power strip to measure the total power consumption of all of the outlets provided on the housing of the advance power strip. This data on total power consumption can be transmitted to the personal computer or other suitable control device through the high level interface.

In one embodiment of the present disclosure, an advanced power strip includes a housing including at least one control outlet, at least one switched outlet, and at least one auxiliary input port. The advanced power strip may be configured for: (1) allowing for master/slave control sensing the current drawn by a control device coupled to the at least one control outlet and, if current is detected, allowing current to be drawn by any device coupled to the at least one switched outlet; and (2) allowing for manual control of the at least one switched outlet.

At least one auxiliary device may be coupled to the at least one auxiliary input port. Manual control of the at least one switched outlet may be effected by the at least one auxiliary device. The at least one auxiliary device may include at least one of the following: a footswitch, a desktop switch, a motion detection sensor, a motion magnetic contact sensor, a motion current detection sensor, a light level sensor, a temperature sensor, an infrared red learner and receiver to momentary/latching digital output, and a timer. A USB port may be provided on the housing for detecting the presence or absence of voltage on a USB port of a connected device. The advanced power strip may be configured to operate in at least three different modes, the modes including: 1) an auxiliary mode in which the at least one switched outlet can only be controlled by at least one auxiliary device; 2) a current mode in which the at least one switched outlet is controlled by the at least one control outlet; and 3) a USB mode in which a USB port in the housing senses the presence or absence of voltage on a USB port of a connected device. When the advanced power strip is in the auxiliary mode, the at least one auxiliary device may be used to either latch or toggle the at least one switched outlet on or off and the at least one control outlet functions as an always on outlet. When the advanced power strip is in the current mode, the at least one switched outlet may turn on when the control device is turned on, and the at least one switched outlet may turn off when the control device is turned off. The at least one control outlet may sense if the control device is above or below a switching threshold and then switch the at least one switched outlet on or off. When the advanced power strip is in the USB mode, the at least one switched outlet may be switched on when the USB port of the connected device is activated, and the at least one switched outlet may be switched off when the USB port of the connected device is deactivated. A high level interface may be positioned within the housing for allowing communication between the advanced power strip and the control device such that the at least one switched outlet is switched on and off by an input received from the control device.

In another embodiment of the present disclosure, a method of operating an advanced power strip includes the steps of: a) providing an advanced power strip; and b) (1) allowing for master/slave control sensing a current drawn by a control device coupled to the advanced power strip and, if current is detected, allowing current to be drawn by any device coupled to advanced power strip; and (2) allowing for manual control of the advanced power strip. A further step may include configuring the advanced power strip to operate in at least three different modes, including a current mode, a USB mode, and an auxiliary mode.

The advanced power strip may include a housing that includes at least one control outlet, at least one switched outlet, and at least one auxiliary input port. A further step of the method may include sensing a current drawn by the control device coupled to the at least one control outlet to allow for master/slave control of the advanced power strip. A further step may include allowing for manual control of the advanced power strip via an auxiliary device coupled to the at least one auxiliary input port. When in the current mode, the at least one control outlet may sense if the control is above or below a switching threshold and switch the at least one switched outlet on or off. When in the USB mode, a USB port on the advanced power strip may sense the presence or absence of the control device connected to the advanced power strip and switch the at least one switched outlet on or off. When in the auxiliary mode, the at least one switched outlet may be controlled by at least one auxiliary device connected to the at least one auxiliary input port. The at least one auxiliary device may include at least one of the following: a footswitch, a desktop switch, a motion detection sensor, a motion magnetic contact sensor, a motion current detection sensor, a light level sensor, a temperature sensor, an infrared red learner and receiver to momentary/latching digital output, and a timer. A further step of the method may include providing a high level interface within the advanced power strip for allowing communication between the advanced power strip and the control device such that the at least one switched outlet is switched on and off by an input received from the control device.

These and other features and characteristics of the present invention, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and the claims, the singular form of “a”, “an”, and “the” include plural referents unless the context clearly dictates otherwise.

### BRIEF DESCRIPTION OF THE DRAWINGS

FIG. 1 is a perspective view of an advanced power strip in accordance with a first embodiment of the present invention;

FIG. 2 is a perspective view of an advanced power strip in accordance with a second embodiment of the present invention;

FIG. 3 is a top plan view of the advanced power strip of FIG. 2;

FIG. 4 is a left side view of the advanced power strip of FIG. 2;

FIG. 5 is a front end view of the advanced power strip of FIG. 2;

FIG. 6 is a rear end view of the advanced power strip of FIG. 2;

FIG. 7 is a truth table and signal diagram when an auxiliary device with latched control is connected to an auxiliary input port of the advanced power strip in accordance with the present invention; and

FIG. 8 is a truth table and signal diagram when an auxiliary device with momentary control is connected to an auxiliary input port of the advanced power strip in accordance with the present invention.

### DETAILED DESCRIPTION OF THE PRESENT INVENTION

For purposes of the description hereinafter, the terms “upper”, “lower”, “right”, “left”, “vertical”, “horizontal”, “top”, “bottom”, “lateral”, “longitudinal”, and derivatives thereof shall relate to the invention as it is oriented in the drawing figures. However, it is to be understood that the invention may assume alternative variations and step sequences, except where expressly specified to the contrary. It is also to be understood that the specific devices and processes illustrated in the attached drawings, and described in the following specification, are simply exemplary embodiments of the invention. Hence, specific dimensions and other physical characteristics related to the embodiments disclosed herein are not to be considered as limiting.

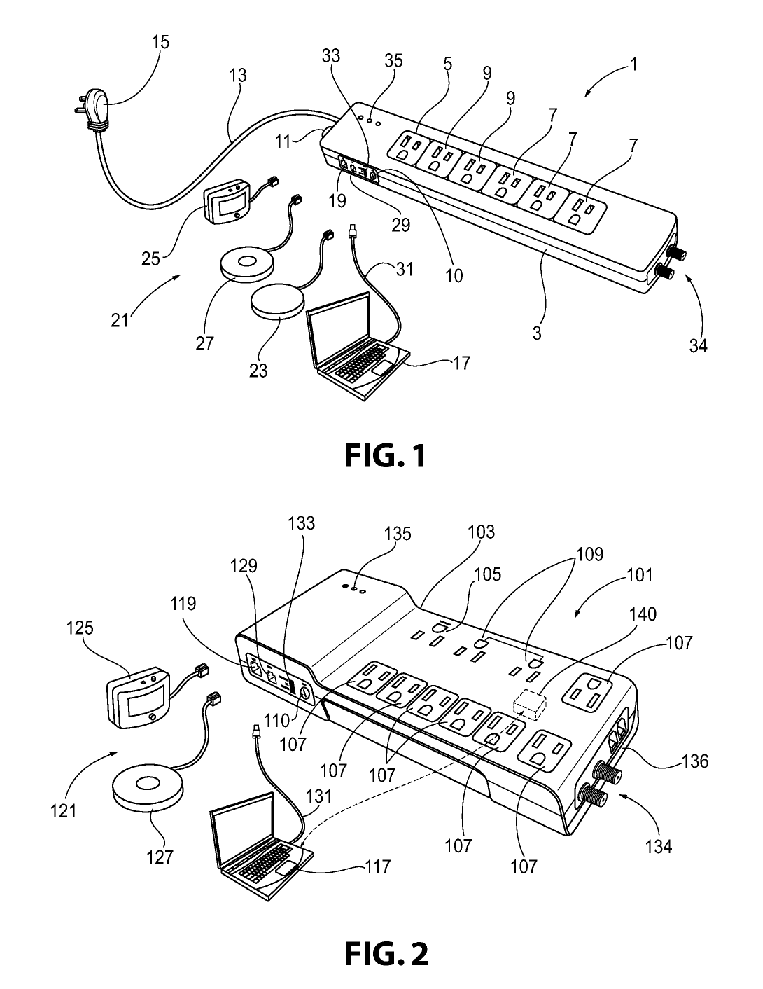

With reference to FIG. 1, an advanced power strip, denoted generally as reference numeral 1, includes a housing 3. Housing 3 is desirably manufactured from a plastic material that is UV stable. Housing 3 may also include a plurality of mounting holes (not shown) on a bottom portion thereof for mounting advanced power strip 1 to a surface, such as a floor or wall. Housing 3 may be substantially rectangular. Housing 3 further includes a control outlet 5, a plurality of switched outlets 7, at least one always-on outlet 9, a resetable circuit breaker with integrated on/off switch 11, and a mains power cord 13 ending in a male mains voltage plug 15 that is configured to be coupled to a female mains voltage receptacle (not shown). This embodiment of advanced power strip 1 includes one control outlet 5, two always-on outlets 9, and three switched outlets 7.

Control outlet 5 measures current draw of a control device, such as a personal computer 17 or television (not shown), and causes switched outlets 7 to switch on or off depending on whether the control device is on or off based on a switching threshold. The switching threshold sets the level at which control outlet 5 determines whether a control device coupled thereto is on or off and thus switches switched outlets 7 on or off. The switching threshold is adjusted by a threshold trimmer 10 provided on housing 3 of advanced power strip 1. The switching threshold may range from about 5 W to about 8 W.

The plurality of switched outlets 7 are switched on a single relay (not shown). The relay is desirably a mechanically latching relay that is rated for a minimum of 100,000 operations at full load. In addition, the relay should be configured to operate with minimum noise such that it is not audible from a distance of more than 2 meters. Always-on outlets 9 remain on at all times as long as on/off switch 11 is in the on position.

Advanced power strip 1 also includes one or more auxiliary input ports 19. Auxiliary input port 19 may be embodied as an RJ11 female connector. Auxiliary input port 19 is designed to receive four (4) signals as follows:

| Pin # | Signal Name | Description |
|---|---|---|
| 1 | VCC (Output) | 3.3 VDC/200 mA supply to an |
| | | auxiliary device. |
| 2 | Momentary (Input) | Input for an auxiliary device |
| | | providing Momentary signals. |
| | | Toggles the state of the Switched Outlets. |
| 3 | Latched (Input) | Input for an auxiliary device providing |
| | | Latched signals. Switched Outlets are |
| | | switched On when Latched signal |
| | | is asserted (high). |
| 4 | GND (—) | Signal/power ground. |

However, the configuration of these inputs is not to be construed as limiting the present invention as an auxiliary input port capable of receiving any suitable number of inputs may be utilized. For instance, the auxiliary input port may be designed to only receive a latching input, a momentary input, or both a latching input and a momentary input.

An auxiliary device 21 is coupled to auxiliary input port 19 to control switched outlets 7. Auxiliary device 21 may be any one of the following: a footswitch 23, a desktop switch (not shown), a motion detection sensor 25, a motion magnetic contact sensor (not shown), a motion current detection sensor (not shown), a light level sensor (not shown), a temperature sensor (not shown), an infrared red learner and receiver 27 to momentary/latching digital output, and a timer (not shown). Auxiliary device 21 is coupled to auxiliary input port 19 via a low voltage cable such as an RJ11 cable.

Advanced power strip 1 also includes a USB port 29 provided on housing for detecting the presence or absence of 5 VDC of a USB port of personal computer 17 coupled thereto by a USB cord 31. USB port 29 may be configured as a USB Type B female connector. Advanced power strip 1 also includes a selector switch 33 provided on housing for selecting between a plurality of modes of operation. The plurality of modes of operation may include auxiliary mode, current mode, and USB mode.

Advanced power strip 1 operates as a normal surge protection product as is known in the art. In addition, a physical interface to a secondary surge protector may be provided, such as the F-type coaxial connector 34 provided on the end face of housing 3 of advanced power strip 1. In addition, other physical interfaces, such as an RJ11/45 interface (not shown), may also be provided on housing 3.

Housing 3 may also include a plurality of LEDs 35 to provide an indication to a user of the status of advanced power strip 1. For instance, the following table lists several LEDs that may be included along with a description of the status that they provide:

| LED | Description |
|---|---|
| Ground | Illuminates when Ground is not connected to mains source |
| (Red) | Ground. |
| Surge | Illuminates when Surge Protection circuitry has failed. |
| (Red) | |
| Power | Illuminates when the APS is powered. |
| (Green) | |
| Switched | Illuminates when Switched Outlets are powered. |
| Outlets | |
| (Green) | |
| System | Illuminates when System platform is being Included/Excluded |
| (Green) | LED is beneath System Configuration (transparent button). |

Please note that this table is not to be construed as limiting the present invention as any suitable configuration of LEDs may be used.

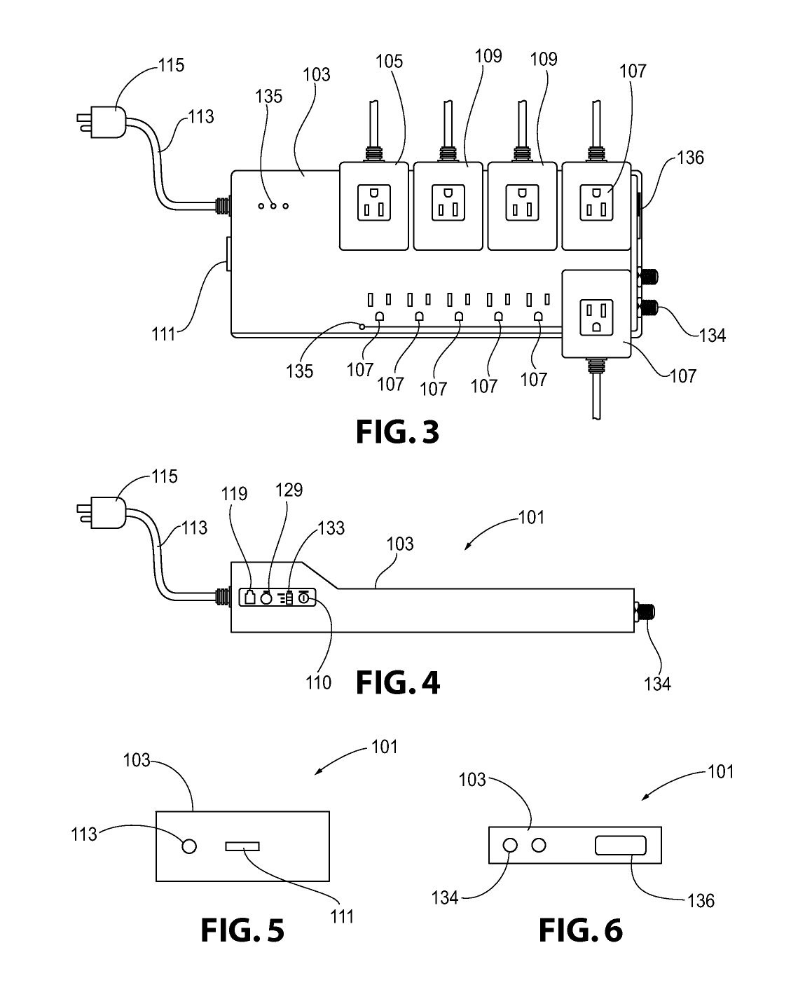

With reference to FIGS. 2-6, a second embodiment of advanced power strip, denoted generally as reference numeral 101, includes a housing 103. Housing 103 is desirably manufactured from a plastic material that is UV stable. Housing 103 may also include a plurality of mounting holes (not shown) on a bottom portion thereof for mounting advanced power strip 101 to a surface, such as a floor or wall. Housing 103 further includes a control outlet 105, a plurality of switched outlets 107, at least one always-on outlet 109, a resetable circuit breaker with integrated on/off switch 111, and a mains power cord 113 ending in a male mains voltage plug 115 that is configured to be coupled to a female mains voltage receptacle (not shown). This embodiment of advanced power strip 101 includes one control outlet 105, two always-on outlets 109, and seven switched outlets 107. However, the configuration of the outlets of the embodiments of FIGS. 1 and 2 are not to be construed as limiting the present invention as any suitable configuration of outlets may be utilized. For instance, an advanced power strip in accordance with the present invention is not required to include a control outlet or an always on outlet. In addition, any suitable number of switched outlets may be provided. If no control outlet is provided, the advanced power strip cannot function in current mode and will only use USB mode and auxiliary mode.

Control outlet 105 measures current draw of a control device, such as a personal computer 117, or television (not shown), and causes switched outlets 107 to switch on or off depending on whether the control device is on or off based on a switching threshold. The switching threshold sets the level at which control outlet 105 determines whether a control device coupled thereto is on or off and thus switches switched outlets 107 on or off. The switching threshold is adjusted by a threshold trimmer 110 provided on housing 103 of advanced power strip 101. The switching threshold may range from about 5 W to about 8 W.

The plurality of switched outlets 107 are switched on a single relay (not shown). The relay is desirably a mechanically latching relay that is rated for a minimum of 100,000 operations at full load. In addition, the relay should be configured to operate with minimum noise such that it is not audible from a distance of more than 2 meters. The use of such a relay is not to be construed as limiting the present invention as any suitable switching device may be utilized within the scope of the present invention. Always-on outlets 109 remain on at all times as long as on/off switch 111 is in the on position.

Advanced power strip 101 also includes one or more auxiliary input ports 119. Auxiliary input port 119 may be embodied as an RJ11 female connector. Auxiliary input port 119 is designed to receive four (4) signals as follows:

| Pin | | |
|---|---|---|
| # | Signal Name | Description |
| 1 | VCC | 3.3 VDC/200 mA supply to an auxiliary device. |
| | (Output) | |
| 2 | Momentary | Input for an auxiliary device providing Momentary |
| | (Input) | signals. |
| | | Toggles the state of the Switched Outlets. |
| 3 | Latched | Input for an auxiliary device providing |
| | (Input) | Latched signals. |
| | | Switched Outlets are switched On when Latched signal |
| | | is asserted (high). |
| 4 | GND (—) | Signal/power ground. |

However, the configuration of these inputs is not to be construed as limiting the present invention as an auxiliary input port capable of receiving any suitable number of inputs may be utilized. For instance, the auxiliary input port may be designed to only receive a latching input, a momentary input, or both a latching input and a momentary input.

An auxiliary device 121 is coupled to auxiliary input port 119 to control switched outlets 107. Auxiliary device 121 may be any one of the following: a footswitch (not shown), a desktop switch (not shown), a motion detection sensor 125, a motion magnetic contact sensor (not shown), a motion current detection sensor (not shown), a light level sensor (not shown), a temperature sensor (not shown), an infrared red learner and receiver 127 to momentary/latching digital output, and a timer (not shown). Auxiliary device 121 is coupled to auxiliary input port 119 via a low voltage cable such as an RJ11 cable.

Advanced power strip 101 also includes a USB port 129 provided on housing 103 for detecting the presence or absence of 5 VDC of a USB port of personal computer 117 coupled thereto by a USB cord 131. USB port 129 may be configured as a USB Type-B female connector. Advanced power strip 101 also includes a selector switch 133 provided on housing for selecting between a plurality of modes of operation. The plurality of modes of operation may include auxiliary mode, current mode, and USB mode.

Advanced power strip 101 operates as a normal surge protection product as is known in the art. In addition, a physical interface to a secondary surge protector may be provided, such as the F-type coaxial connector 134 provided on the end face of housing 3 of advanced power strip 1. In addition, other physical interfaces, such as an RJ11/45 interface 136, may also be provided on housing 103.

Housing 103 may also include a plurality of LEDs 135 to provide an indication to a user of the status of advanced power strip 101. For instance, the following table lists several LEDs that may be included along with a description of the status that they provide:

| LED | Description |
|---|---|
| Ground | Illuminates when Ground is not connected to mains source |
| (Red) | Ground. |
| Surge | Illuminates when Surge Protection circuitry has failed. |
| (Red) | |
| Power | Illuminates when the APS is powered. |
| (Green) | |
| Switched | Illuminates when Switched Outlets are powered. |
| Outlets | |
| (Green) | |
| System | Illuminates when System platform is being Included/Excluded |
| (Green) | LED is beneath System Configuration (transparent button). |

Please note that this table is not to be construed as limiting the present invention as any suitable configuration of LEDs may be used.

The operation of advanced power strip 1 and advanced power strip 101 is generally the same so the operation of the present invention will be discussed hereinafter in relation to advanced power strip 101. Generally, advanced power strip 101 can be configured to either a) allow for master/slave control by sensing the current produced by a control device coupled to control outlet 105, and, if current is detected, allowing current to be drawn by any device coupled to the switched outlets 107; or b) allow for manual or automatic control of the switched outlets 107 via auxiliary device 121 coupled to auxiliary input port 119. More specifically, advanced power strip 101 of the present invention includes different selectable modes whereby: different relationships can be assigned between an input (or combination of inputs) and outlets; outlets can function in different ways subject to the Mode that is selected on the power strip; and Master/Slave functionality (via current sensing or USB port voltage sensing) and concurrent and/or independent control of selected outlets via a wired, low voltage, external auxiliary input device can be provided. For instance, several of these modes will be discussed hereinafter.

To use advanced power strip 101, a user first selects current mode, USB mode, or auxiliary mode using the selector switch 133. If current mode is selected, a user may adjust the switching threshold using threshold trimmer 110 prior to use. When in current mode, switched outlets 107 turn on or off with control outlet 105. Control outlet 105 senses if the control device, such as personal computer 117 or a television, coupled thereto is above or below a switching threshold as set by threshold trimmer 110 and then switches switched outlets 107 on or off. When in current mode, auxiliary device 121 can be used to toggle or latch switched outlets 107.

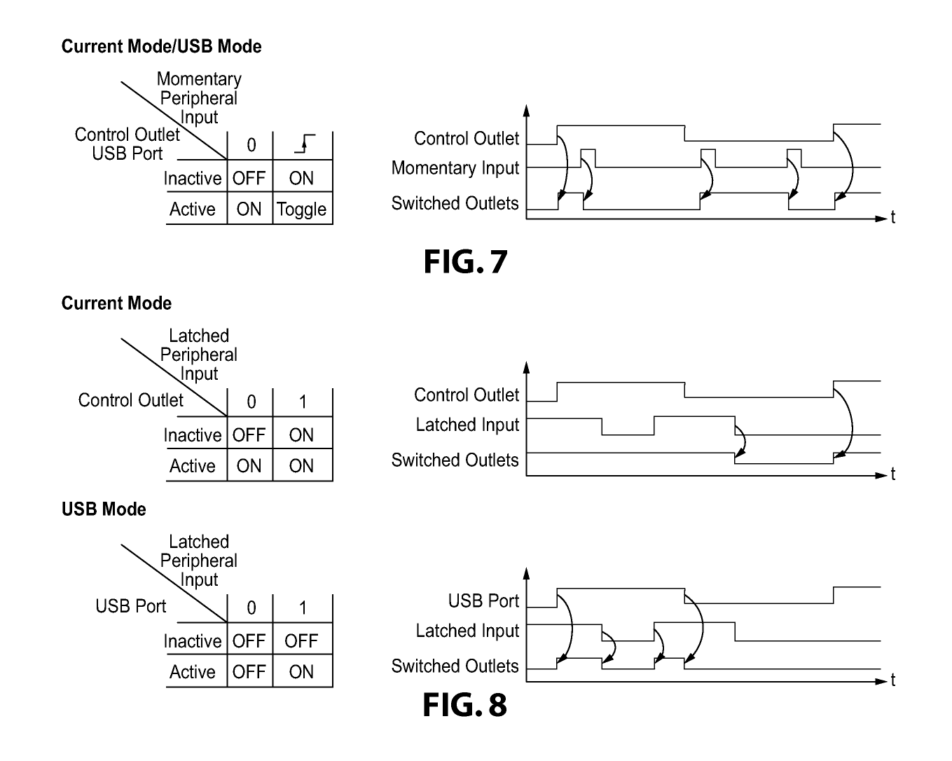

When in auxiliary mode, switched outlets 107 can only be controlled by auxiliary device 121. Auxiliary device 121 may be any one of the following: a footswitch (not shown), a desktop switch (not shown), a motion detection sensor 125, a motion magnetic contact sensor (not shown), a motion current detection sensor (not shown), a light level sensor (not shown), a temperature sensor (not shown), an infrared red learner and receiver 127 to momentary/latching digital output, and a timer (not shown). However, this is not to be construed as limiting the present invention as any suitable switching device may be used. The current detecting performed by control outlet 105 and/or the USB port 129 is disabled. The auxiliary device 121 can be used to toggle or latch the switched outlets 107 on or off. Auxiliary device 121 may provide either a momentary control signal or a latched control signal to auxiliary input port 119. When an auxiliary device 121 with momentary control is connected, switched outlet 107 must toggle power level on the rising edge of the momentary signal (pulse) as shown in the truth table and signal diagram in FIG. 7. When an auxiliary device 121 with latched control is connected, switched outlets 107 must be switched as shown in the truth table and signal diagram of FIG. 8.

When in USB mode, USB port 129 senses the presence or absence of 5 VDC on the USB port of personal computer 117. When personal computer 117 is on, the USB port of personal computer 117 is on, 5 VDC is sensed by USB port 129, and switched outlets 107 are switched on. On the other hand, when personal computer 117 is off, the USB port of personal computer 117 is off, no voltage is sensed, and switched outlets 107 are switched off. Control outlet 105 operates as an always-on outlet when in USB mode. In addition, auxiliary device 121 can be used to toggle or latch switched outlets 107.

Advanced power strip 101 may further include a high level interface 140 positioned within the housing for allowing communication between advanced power strip 101 and personal computer 117 or any other suitable control device. This communication may be performed over a hard wire connection or wirelessly. The high level interface 140 allows advanced power strip 101 to also operate in system mode. When in system mode, switched outlets 107 are switched on or off by an input received from personal computer 117 or other suitable control device through the high level interface 140. When in system mode, auxiliary device 121 can be used to toggle or latch switched outlets 107. System mode also supports current measurement. Current measurement is the ability of advanced power strip 101 to measure the total power consumption of all of the outlets provided on housing 103 of advanced power strip 101. This data on total power consumption can be transmitted to personal computer 117 or other suitable control device through the high level interface 140.

Accordingly, the advanced power strip of the present invention allows for the use of: 1) selectable/configurable modes, along with 2) master/slave functionality and/or external manual control.

Although the invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements. For example, it is to be understood that the present invention contemplates that, to the extent possible, one or more features of any embodiment can be combined with one or more features of any other embodiment.

The invention claimed is:

1. An advanced power strip, comprising:
a housing, comprising:
at least one control outlet;
at least one switched outlet; and
at least one auxiliary input port;
wherein the advanced power strip is configured for: (1) allowing for master/slave control by sensing the current drawn by a control device coupled to the at least one control outlet and, if current is detected, allowing current to be drawn by any device coupled to the at least one switched outlet; and (2) allowing for manual control of the at least one switched outlet.

2. The advanced power strip as claimed in claim 1, further comprising at least one auxiliary device coupled to the at least one auxiliary input port,
wherein manual control of the at least one switched outlet is effected by the at least one auxiliary device.

3. The advanced power strip as claimed in claim 2, wherein the at least one auxiliary device comprises at least one of the following: a footswitch, a desktop switch, a motion detection sensor, a motion magnetic contact sensor, a motion current detection sensor, a light level sensor, a temperature sensor, an infrared red learner and receiver to momentary/latching digital output, and a timer.

4. The advanced power strip as claimed in claim 1, further comprising a USB port provided on the housing for detecting the presence or absence of voltage on a USB port of a connected device.

5. The advanced power strip as claimed in claim 1, wherein the advanced power strip is configured to operate in at least three different modes, the modes comprising:
1) an auxiliary mode in which the at least one switched outlet can only be controlled by at least one auxiliary device;
2) a current mode in which the at least one switched outlet is controlled by the at least one control outlet; and
3) a USB mode in which a USB port in the housing senses the presence or absence of voltage on a USB port of a connected device.

6. The advanced power strip as claimed in claim 5, wherein, when the advanced power strip is in the auxiliary mode, the at least one auxiliary device is used to either latch or toggle the at least one switched outlet on or off and the at least one control outlet functions as an always on outlet.

7. The advanced power strip as claimed in claim 5, wherein, when the advanced power strip is in the current mode, the at least one switched outlet turns on when the control device is turned on, and the at least one switched outlet turns off when the control device is turned off.

8. The advanced power strip as claimed in claim 7, wherein the at least one control outlet senses if the control device is above or below a switching threshold and then switches the at least one switched outlet on or off.

9. The advanced power strip as claimed in claim 5, wherein, when the advanced power strip is in the USB mode, the at least one switched outlet is switched on when the USB port of the connected device is activated, and the at least one switched outlet is switched off when the USB port of the connected device is deactivated.

10. The advanced power strip as claimed in claim 1, further comprising a high level interface positioned within the housing for allowing communication between the advanced power strip and the control device such that the at least one switched outlet is switched on and off by an input received from the control device.

11. A method of operating an advanced power strip, comprising the steps of:
a) providing an advanced power strip; and
b) (1) allowing for master/slave control sensing a current drawn by a control device coupled to the advanced power strip and, if current is detected, allowing current to be drawn by any device coupled to advanced power strip; and (2) allowing for manual control of the advanced power strip.

12. The method of operating an advanced power strip as claimed in claim 11, wherein the advanced power strip comprises:
a housing, comprising:
at least one control outlet;
at least one switched outlet; and
at least one auxiliary input port.

13. The method of operating an advanced power strip as claimed in claim 12, further comprising the step of sensing a current drawn by the control device coupled to the at least one control outlet to allow for master/slave control of the advanced power strip.

14. The method of operating an advanced power strip as claimed in claim 12, further comprising the step of allowing for manual control of the advanced power strip via an auxiliary device coupled to the at least one auxiliary input port.

15. The method of operating an advanced power strip as claimed in claim 12, further comprising the step of configuring the advanced power strip to operate in at least three different modes, including a current mode, a USB mode, and an auxiliary mode.

16. The method of operating an advanced power strip as claimed in claim 15, wherein, when in the current mode, the at least one control outlet senses if the control is above or below a switching threshold and switches the at least one switched outlet on or off.

17. The method of operating an advanced power strip as claimed in claim 15, wherein, when in the USB mode, a USB port on the advanced power strip senses the presence or absence of the control device connected to the advanced power strip and switches the at least one switched outlet on or off.

18. The method of operating an advanced power strip as claimed in claim 15, wherein, when in the auxiliary mode, the at least one switched outlet is controlled by at least one auxiliary device connected to the at least one auxiliary input port.

19. The method of operating an advanced power strip as claimed in claim 18, wherein the at least one auxiliary device comprises at least one of the following: a footswitch, a desktop switch, a motion detection sensor, a motion magnetic contact sensor, a motion current detection sensor, a light level sensor, a temperature sensor, an infrared red learner and receiver to momentary/latching digital output, and a timer.

20. The method of operating an advanced power strip as claimed in claim 11, further comprising the step of providing a high level interface within the advanced power strip for allowing communication between the advanced power strip and the control device such that the at least one switched outlet is switched on and off by an input received from the control device.
